(19) United States
(12) Patent Application Publication
(10) Pub. No.: US 2002/0158882 A1
(43) Pub. Date: Oct. 31, 2002

(54) Auto gamma correction system and method for displays with adjusting reference voltages of data drivers

(76) Inventors: Ming-Jiun Liaw, Hsinchu (TW); Ming-Daw Chen, Hsinchu (TW); Ho-Hsin Yang, Tainan (TW)

Correspondence Address: Raymond Sun, 12420 Woodhall Way, Tustin, CA, 92782, US

(21) Appl. No.: 09/816,511

(22) Filed: Mar. 23, 2001

(51) Int. Cl. G09G 5/00

(52) U.S. Cl. 345/589

(57) ABSTRACT

This invention is related to an auto Gamma correction system for displays with adjusting reference voltages of data drivers, wherein a novel correction method by adjusting the external reference voltages of the data drivers was proposed. The auto gamma correction system mainly includes an auto gamma correction system coupled to the data drivers. The auto gamma correction system outputs plurality adjustable Gamma voltages coupled to the data drivers to drive the display without any gray level loss. Further, because of its requirement of no detector or just low-cost detectors, the invention enables display manufactories to get the advantage of cost-down.

### BACKGROUND OF THE INVENTION

1. Field of the Invention

This invention relates to an auto gamma correction system and method for displays with adjusting reference voltages of data drivers, in which a novel gray level adjusting method is proposed to generate gray patches, and then to adjust the reference voltages of data drivers with no detectors or low-cost detectors in good performance for displays.

2. Description of the Prior Art

Recently, the technology in the field of displays has grown rapidly with the fast development in opto-electronics area. However, for a display (a television having a conventional picture tube or a state-of-the-art thin film transistor-liquid crystal display), the realization of the correction of Gamma parameters has become a key technology. The correction of Gamma parameters is one of the major considerations in the development of display industry. However, due to the inevitable process unreliability, the characteristics of each display are somewhat different, therefore, the individual correction of Gamma parameters of each display is required. It suffers from waste of time and high manufacturing cost. So an auto Gamma correction system is developed to simplify the production and cost-down.

Accordingly, in the prior arts, in order to achieve automatic correction of Gamma parameters, it has been provided a feedback system with a sensor disposed inside the display, as shown in FIG. 1. Such knowledge is disclosed, for example, in the U.S. Pat. No. 6,046,719 as entitled “Column Driver With Switched-Capacitor D/A Converter” filed on Jul. 7th, 1997. As shown in the drawing, a temperature sensor (1014) is disposed in the liquid-crystal display (1012). The lifetime of the display is taken into consideration to calculate the Gamma parameters and perform Gamma correction (1010). Later, the correction result is further input into the column driver (i.e., the data driver) (1018) display. Therefore, the signal voltage is fixed.

However, such a conventional technology, as shown in FIG. 1, has the major disadvantage as:

(1) Need of built-in temperature detector used to operator.

(2) The image would get lost of the gray-level under using the changed corresponding value of image gray-level.

(3) The undeserved effect for Gamma correction resulted from user changed the setting of display is unconsidered.

Another conventional circuit configuration, as shown in FIG. 2, is provided to improve the control system for the uniformity in luminance and/or color of the display. Such knowledge is disclosed, for example, in the U.S. Pat. No. 6,043,797 as entitled “Color and Luminance Control System for Liquid Crystal Projection Display” filed on Nov. 5th, 1996. As shown in the drawing, the display is divided into nine sections (12A˜12N) and their corresponding control units perform the correction of Gamma parameters respectively. The detailed circuits of the embodiments of such a disclosure are shown in FIGS. 3A, 3B and 3C, illustrating the input analog and/or digital RGB signals and the controlling approaches of display driving.

However, such a conventional technology, as shown in FIGS. 2 and 3, has the major disadvantages as:

(1) At first, user must calculate all the Gamma parameter correction curves to storage into the look-up table for every one display.

(2) The image would get lost of the gray-level under using the changed corresponding value of image gray-level.

Furthermore, another main disadvantage of the prior arts in FIGS. 1 and 2 is that the display systems need a precision opto-detector to get better image correction. Unfortunately, the most users have no detectors to detect the V-T curve (Voltage-Optical-response curve) or the V-R curve (Voltage-Reflection curve) for displays. As a result, the image quality of the displays is adversely affected, further to make the user to execute Gamma correction inconvenience.

### SUMMARY OF THE INVENTION

It is thus the primary object of the present invention to provide an automatic Gamma parameter correction system in which a novel gray level adjusting method is proposed to generate gray patches, and then to adjust the reference voltages of data drivers with no detectors or low-cost detectors in good performance for displays.

Another object of the present invention is to provide the display manufactories to adjust their products with more potential compared with traditional methods.

In order to achieve the described above object, the present invention provides a display correction system that mainly includes an auto gamma correction system coupled to a group of data drivers. For more detail description, the auto gamma correction system at least including a central processing unit (CPU), an image generator, a memory, and a group of programmable gamma voltage generating circuits. The connection between these elements is that the different outputs of CPU coupled to the image generator and the group of programmable gamma voltage generating circuits, the CPU also connected with the memory in bi-direction. The group of programmable gamma voltage generating circuits could output different voltages coupled to the data drivers. Wherein, the CPU determines the target Gamma reference voltages based on users' visual matching process after taking into considerations the code-to-voltage transfer functions of the data drivers, then produces a better image quality without any loss of gray-levels.

For the preferable embodiment method description, the present invention provides many auto Gamma correction methods, one of the correction methods that comprising: (1) Selecting two of Gamma reference voltages, then generating two gray patches, one is generated by spatial dithering technology, and the other is a continuous pixel gray patch. (2) Adjusting the digital code of the continuous pixel gray patch from a distance, until the luminance of continuous pixel gray patch looks matching that of the spatial dithering gray patch, then recording the final digital code d₁ of the continuous pixel gray patch. (3) Generating another two gray patches that are different from those of the step (1), one is generated by spatial dithering technology, the other is a continuous pixel gray patch. (4) Adjusting the digital code of the continuous pixels gray patch from a distance, until the luminance of gray patch looks matching that of the spatial dithering gray patch, recording the final digital code d₂ of the continuous pixel gray patch. (5) Figuring out the voltage values (V_{d1}, V_{d2}) corresponded to the digital codes (d₁, d₂) by the interpolation method with the built-in code-to-voltage transfer function. (6) Finding out final target voltage values for the two selected external Gamma reference voltages. (7) Repeating the steps (3)˜(6) until the target numerical values of all Gamma reference voltages are figured out. (8) Adjusting the Gamma voltages to match with their target values by the programmable Gamma voltage generating circuits; and applying these Gamma voltages to the data drivers, then storing the adjusted Gamma reference voltages into a memory to complete the auto Gamma correction.

Furthermore, the other methods will be detail described in the detailed description of this invention as follow, and there is also an embodiment for the auto Gamma correction system with at least a detector in the detailed description.

### BRIEF DESCRIPTION OF THE DRAWINGS

The objects, spirits and advantages of the preferred embodiment of the present invention will be readily understood by the accompanying drawings and detailed descriptions, wherein:

FIG. 1 is a schematic circuit diagram of one embodiment in the U.S. Pat. No. 6,046,719;

FIG. 2 is a schematic circuit diagram of one embodiment in the U.S. Pat. No. 6,043,797;

FIG. 3 shows different circuits from the circuit as shown in FIG. 2 in the U.S. Pat. No. 6,043,797;

FIG. 4 is a graph illustrating a group of external Gamma reference voltages of data drivers and the corresponding digital codes to the reference voltages;

FIG. 5 is a graph illustrating for a circuitry diagram in accordance with first embodiment of the present invention;

FIG. 6A is a lookup table of the relative gray-level and relative luminance corresponding to the Gamma reference voltage;

FIG. 6B is a curve illustrating for the Gamma reference voltage verse the optical-response;

FIG. 7 is an example graph illustrating images for user to execute Gamma correction;

FIG. 8 is an example graph illustrating the corresponding gray patches generated by the spatial dithering could be complemented 1- or 2-dimmentionally;

FIG. 9 is a graph illustrating for using three continuous gray-level to decide the reference voltages V₂′ and V₇′;

FIG. 10 a graph illustrating for a circuitry diagram in accordance with second embodiment of the present invention.

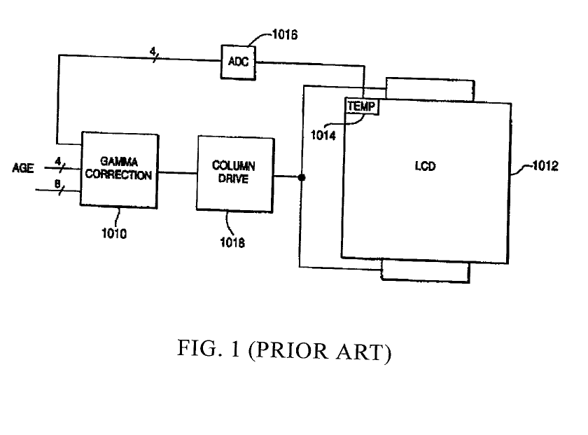

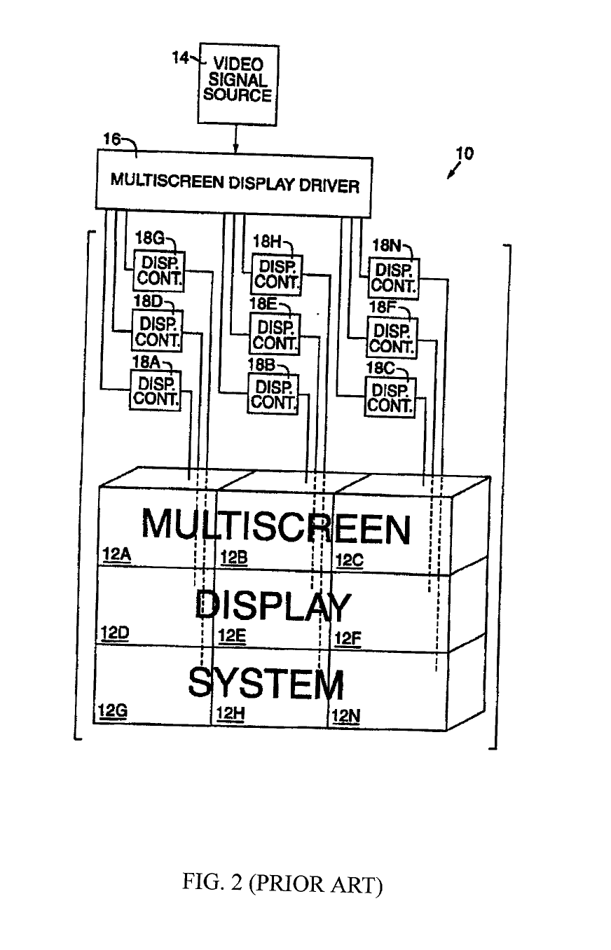

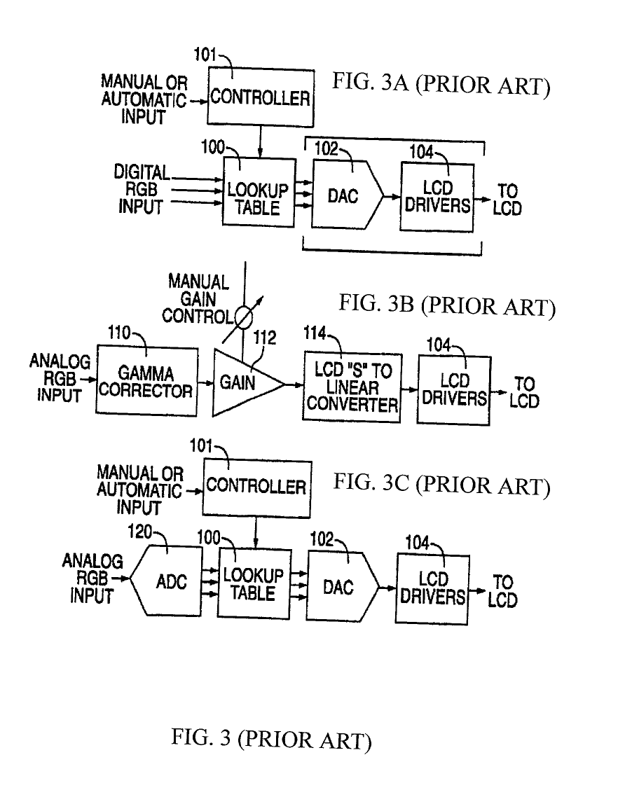

### DETAILED DESCRIPTION OF THE INVENTION

The present invention is related to an auto gamma correction system and method for displays with adjusting reference voltages of data drivers, especially about LCD displays, in which the image gray levels of displays can be shown without any loss, even the user does not have the detector or use the low-cost detectors to execute Gamma correction. This invention proposes a novel gray level adjusting method to generate the gray patches, and then to adjust the reference voltages of data drivers in good performance for displays to provide the display manufactories to adjust their products with more potential compared with traditional methods.

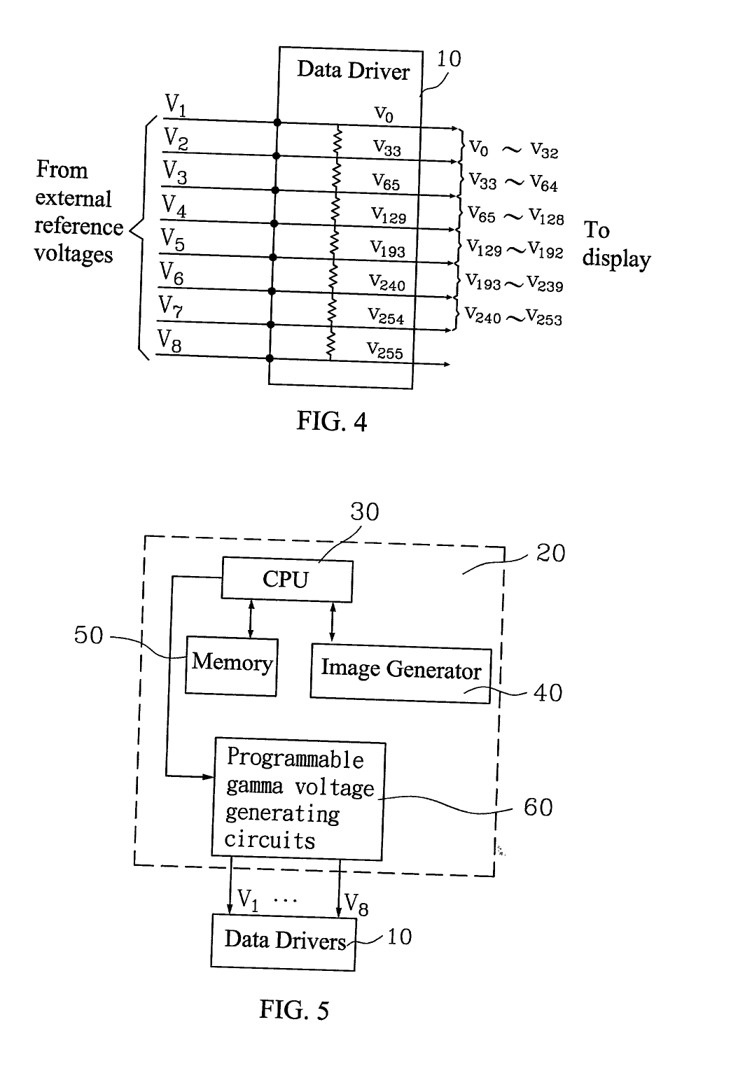

To establish proper code-to-optical-response curve, the data drivers 10 of LCD display require a series of external reference voltages (V₁˜V₈) provided by a group external electric circuits as shown in FIG. 4 which illustrates a group of external Gamma reference voltages of data drivers 10 and the corresponding digital codes to the reference voltages. Wherein, v₀˜v₂₅₅ represent voltages corresponding to different gray-levels. Based on this, the Gamma correction method of this invention is to adjust Gamma reference voltages directly instead of replacing digital codes of the input images.

### First Embodiment. The Detectors Useless

For describing the hard ware structure of an auto gamma correction system in this invention, please refer to FIG. 5, which illustrates a circuitry diagram in accordance with first embodiment of the present invention. FIG. 5 mainly includes an auto gamma correction system 20 coupled to the data drivers 10. For more detail description, the auto gamma correction system 20 at least including a central processing unit (CPU) 30, an image generator 40, memory 50, and a group of programmable gamma voltage generating circuits 60. The connection between these elements is that the different outputs of CPU 30 coupled to the image generator 40 and the group of programmable gamma voltage generating circuits 60, the CPU 30 also connected with the memory 50 in bi-direction. The group of programmable gamma voltage generating circuits 60 could output different voltages V₁˜V₈ coupled to the data drivers. In FIG. 5, there are only eight Gamma reference voltages V₁˜V₈ used as an embodiment. In practically, the number of Gamma reference voltages depends on the requirements of data drivers.

The main functions of the above elements in FIG. 5, are described as follow:

CPU 30: Computing a string of digital codes that will be referenced during the correction process.

Image generator 40: The input of the image generator 40 is couple to the CPU 30 to generate at least two kinds of gray patches. One is produced by the technology of 1- or 2-dimensional spatial dithering, the other is produced by directly driving continuous pixels. The spatial dithering gray patch will be taken a reference one, and user can adjust digital codes of the continuous-pixel patches.

Memory 50: Coupling with the CPU 30 to store the target numerical values of Gamma reverence voltages of data drivers that will be described below, further store a set of code-to-voltage transfer functions of the data drivers and at least a target code-to-optical-response curve. Since the code-to-voltage transfer functions of data drivers from various companies may be quite different, the transfer function should be also recorded in the memory according to the data sheet of the data drivers 10.

A group of programmable Gamma voltage generating circuits 60: Providing Gamma voltages to the data drivers 10 according to numerical values computed by CPU 30, such that the target code-to-optical-response curve can be achieved.

A group of data drivers 10, requiring a series of external reference voltages, hereinafter referred as Gamma reference voltages or Gamma voltages, to generate outnumbered analog voltages for the display to present adequate gray levels.

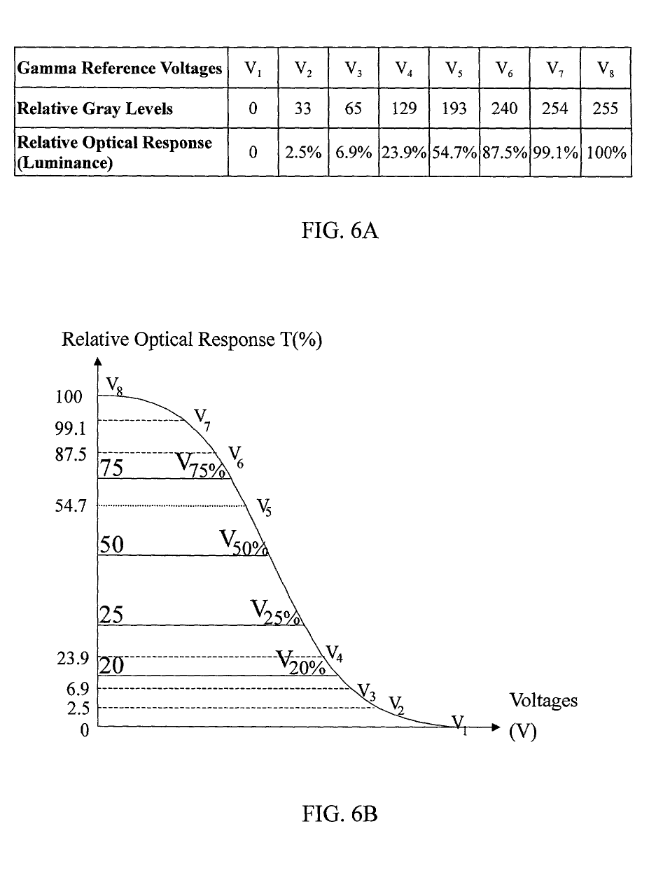

As mention above, the CPU 30 determines the target Gamma reference voltages based on users' visual matching process after taking into considerations the code-to-voltage transfer functions of the data drivers 10, then produces a better image quality without any loss of gray-levels. Furhter, every display has its own default Gamma correction, in other words, a default Gamma reference voltages was already inputted into the data drivers 10 before applying the new invention. The meaning of Gamma correction of the present invention is to re-determine eight Gamma voltages (V₁˜V₈) according to electric-optical transfer characteristic of the display. For the data drivers 10 shown in FIG. 5, there are eight voltages (V₁˜V₈) should be re-determined. For more clear explanations, the digital codes and optical-response (means the luminances) corresponding to these eight voltages are assumed and listed in the 3rd row of FIG. 6A and in the vertical axis of FIG. 6B, respectively. Since V₁ and V₈ will be remained in-various when the contrast, brightness, and other color performance parameters has been set, only six voltages V₂˜V₇ are left to be redetermined.

To explain the operation principle more convenience in this invention, we assume that the selected data driver 10 must input eight Gamma voltages (V₁˜V₈). The corresponded relative gray-levels corresponded to the Gamma voltages are shown in FIG. 6. When the target curve of digital codes-optical-response has been decided, we assume that the corresponding values of the relative optical-response (also means the relative luminances) be the percentage values shown in the 3^{rd} row of FIG. 6A. Meanwhile, the auto Gamma correction system must determine the values of Gamma voltages (V₁˜V₈) to make the voltages transferred from the data drivers 10 correspond with the curve of digital codes-optical-response and to be matched with the target curve. Since the contrast and brightness of display had been set before, then the maximum and minimum voltages V₁˜V₈ have been decided, there are only six voltages V₂˜V₇ needed to be determined.

### Method 1. Using Two Gray-Levels to Generate the Arbitrary Gray Patches

The first method of this invention is that only two gray levels with optical-response of 0% and 100% are used to generate gray patches with another gray levels. The steps of the first method are described as follow coordination with FIGS. 6A and 6B:

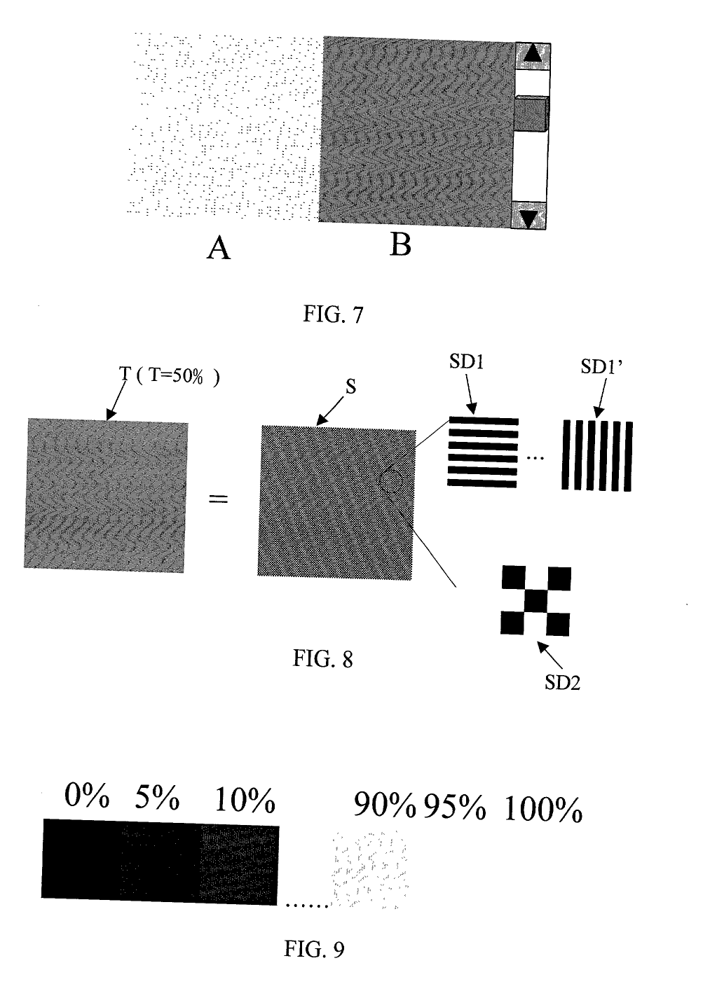

Step 1: Select adjacent two of Gamma reference voltages, wherein several gray levels exist, to be first corrected, further to generate two gray patches. One gray patch is generated by spatial dithering technology, the other is a continuous pixel gray patch. The luminance of these two patches should be within those bounded by the two selected Gamma voltages. The two gray patches are generated by the image generator 40. The gray patch by spatial dithering is cooperated with the ratio of black and white gray levels in 1:1, to produce a relative luminance (means the optical-response) 50% gray patch as the gray patch A shown in FIG. 7. The gray patch A can also be generated by the frame rate control technology. The other gray patch is the continuous pixel gray patch B shown in FIG. 7 with a continuous pixel in a single one gray level. The gray level of continuous pixel gray patch B can be adjusted immediately by moving the scroll bar in different position in a window. The principle of spatial dithering to produce a gray patch would be explained after all the steps have been described.

Step 2: User adjusts the digital-code of the continuous pixel gray patch B from a distance, until the luminance of the gray patch B looks matching that of the gray patch A. Hereinafter, this process is referred as users' visual matching process. At this time, the ongoing display system stores the final digital code d₁ of continuous pixel gray patch B into the memory 50 or into the programs in the CPU 30.

Step 3: To generates another two gray patches that differ from those of step 1 by the image generator 40. One is produced by the spatial dithering technology with the ratio of black and white gray level in 3:1, to generate a relative luminance (means the optical-response) 25% gray patch (the 25% gray-level is corresponded between the V₄ and V₅ in the curve of FIG. 6B). The gray patch A could be also generated by the frame rate control technology. The other gray patch B is a continuous pixel in a single one gray level, and the gray-level of the continuous pixel gray patch B could be adjusted.

Step 4: User adjusts the digital-code of the continuous pixel gray patch B from a distance, until the luminance of the gray patch B looks matching with the gray patch A. Meanwhile, the ongoing display system stores the final digital code d₂ of the continuous pixel gray patch B into the memory 50 or into the programs in the CPU 30.

Step 5: The voltage values (V_{d1}, V_{d2}, for example as the V_{50%}, V_{25%}) with the digital codes (d₁, d₂) are figured out by using the lookup table or the interpolation method in accordance with the built-in code-to-voltage transfer function stored in the memory 50 for data drivers 10 and the external reference voltages of the data drivers 10.

Step 6: The relative gray-levels (D_{50%}, D_{25%}) corresponded to the optical-response of 50% (T1) and 25% (T2) are found out according to the built-in target code-to-luminance transfer function stored in the memory 50. And then, based on the built-in function of the data drivers, we figure out the final target voltage values for the two selected external Gamma reference voltages V_{4′}, V_{5′} through the relative gray-levels (D_{50%}, D_{25%}) and the voltages (V_{50%}, V_{25%}). The figuring formulas shown as follows (more descriptions for the formulas will be explained after all the steps have been described):

V4+c(d1)×(V4−V5)=V_{d1}=V4′+c(D_{T1})×(V5′−V 4′) (1)

V4+c(d2)×(V4−V5)=V_{d2}=V4′+c(D_{T2})×(V5′−V 4′) (2)

Step 7: Repeat the step 1 to step 6 to figure out the target numerical values of the entire Gamma reference voltages. So far, all the Gamma reference voltages V₂′˜V₇′ have been determined. The V₁′, V₈′ had been determined while the contrast and the brightness of display were set by the user before. Then all the voltages V₁′˜V₈′ have been figured out.

Step 8: After all the Gamma reference voltages have been figured out, we use the programmable Gamma voltage generating circuits 60 to adjust the input voltages of the data drivers 10 to match with the target values for the auto Gamma correction system. Meanwhile, applying these Gamma voltages to the data drivers 10, then storing the adjusted Gamma reference voltages into the memory 50 to complete the auto Gamma correction. On the other hand, the user could adjust the input voltage of the data drivers 10 once immediately after determining one Gamma reference voltage value, that will be the Method 2.

As mentioned above, we further describe about the principle of the spatial dithering briefly. The spatial dithering is a common technology to expand the number of gray levels of display systems. To display two gray patches with different area ratio in a screen as shown in FIG. 8, the spatial dithering technology generates an effective gray level in visual perception. Wherein, the T is a gray patch in continuous pixel, example, the 50% optical-response. The S is a gray patch generated by the spatial dithering technology. The optical-response level of S is also the 50% level.

In mathematics, the optical-response (or reflection), say T, of the effective gray patch generated by spatial dithering can be express as follows:

$${T}_{i} = \frac{a}{a + b} \times {T}_{1} + \frac{b}{a + b} \times {T}_{2} \qquad ( 3 )$$

wherein, T₁ and T₂ are optical-response (or reflections) of two gray-level patches used to generate the effective gray level with an area ratio of a:b. For example, we can use the optical-response 100% and 0% to produce the 10% optical-response (the area ratio of 1:9), 20% (the area ratio of 1:4), 25% (the area ratio of 1:3), 75% (the area ratio of 3:1), 80% (the area ratio of 4:1), 90% (the area ratio of 9:1). Further, in order to avoid the flick phenomena, the gray patch S could be also produced by the frame rate control technology.

The spatial dithering technology can be implemented 1- or 2-dimmentionally. If the working display suffers cross-talk in electrical system or in display media seriously, 1-dimentional dithering is suggested. In such case, for analog transmitter in display card, alternative black and white lines are preferred along the horizontal direction likes the SD1 shown in FIG. 8. The SD1′ represents the alternative black and white lines are preferred along the vertical direction. The SD2 is the spatial dithering technology in two dimensions.

Mathematically, steps 1˜6 can be expressed as the above two equations (1), (2), wherein V₄ and V₅ denote the original 4^{th} and 5^{th} reference voltages before correction. Gamma reference voltages V₄′ and V₅′ are the desired voltages to get proper gamma correction curve. Steps 1˜5 link the first two items in these two equations (1), (2) and provide data for CPU 30 to compute V_{50%} and V_{25%} after the d₁ and d₂ being determined. The purpose of Step 6 is establishing equalities of the last two items in both equations. Since D₅₀ and D₂₅ are well known when specified data drivers are used. Further, V₄′ and V₅′ can be obtained by CPU 30 according to the above Eq. (2) and (3). V₄′ and V₅′ are then recorded into the memory 50.

### Method 2. Using the Specific Gray-Level to Generate the Gray Patches

The main difference between the method 1 and 2 is that the method 2 adjusts the input voltage of the data drivers 10 into the target value once immediately while a reference voltage has been determined. Thus, method 2 repeats the steps 1˜6 of method 1 at first and then executes its own procedures.

The steps of method 2 are described as follow:

Step 1: Repeating the steps 1˜6 of method 1 to determine the target voltages of V₄′ and V₅′.

Step 2: Adjusting these two Gamma voltages, V₄′ and V₅′, to their target voltages via the programmable Gamma voltage generating circuits 60; then applying the two voltages to the data drivers 10.

Step 3: Selecting another one Gamma voltage to be next adjusted; then determining one gray-level for the spatial-dithering gray patch of this selected Gamma voltage according to a set of pre-storage gray levels corresponded to the external reference voltages of the data drivers. Basically, the principle of determining the gray-level of the next gray patch is that using the blackest, the whitest or a preset gray-level (likes as the luminance 50% ), and applying the integer area ratio near to the 1:1 to generate the gray-level. For example, we could apply the gray-levels 100% and 50% to produce the 83.3% gray-level (the area ratio of 2:1), 75% (the area ratio of 1:1), 66.7% (the area ratio of 1:2), further, or using the gray-levels 50% and 0% to produce the 33.3% gray-level (the area ratio of 2:1), 25% (the area ratio of 1:1), 16.7% (the area ratio of 1:2) for different gray-level.

Step 4: Generating a gray patch with the determined gray level by means of spatial dithering technology; then determining the target voltage value of the selected Gamma voltage via the users' visual matching process.

Step 5: Adjusting immediately the input Gamma voltage of data drivers to its target value by the programmable Gamma voltage generating circuits 60 after the target value has been determined. That is applying the spatial dithering technology (and/or the frame rate control technology) to generate the gray-level which decided by the CPU 30. Repeat steps 1-2 to determine the target voltage value of the next gamma reference voltage; and then, deliver the voltage obtained by group programmable Gamma voltage generating circuits 60 to the data drivers 10.

Step 6: Repeating step (1)˜(5) until all the Gamma reference voltages have been set. Wherein, after step 5, that is using the group programmable Gamma voltage generating circuits 60 to adjust the output voltages of the circuits 60 to match the target values while a target voltage corresponded with a gray-level has been decided. And then, the CPU 30 decided the gray patch of the next adjusted voltage, until all the voltages corresponded with different gray-level have been set. After that, the auto gamma correction has been completed.

For the method 1 and 2 mentioned above, at last, it is difficult to adjust the reference voltages for the gray-levels of almost full black or white under using the spatial dithering technology. This invention proposes the method 3 to adjust the Gamma reference voltage for the gray-levels of almost full black or white in the methods 1 and 2.

### Method 3. Determining the Reference Voltages of the Gray-Levels of Almost Full Blabk and White

It is very difficult to generate the precision gray-levels of almost full black and white by using the spatial dithering technology in the methods 1 and 2. For example, the relative optical-response (or luminance) 2.5% ˜6.9% corresponded with the Gamma reference voltages V₂, V₃, and the relative optical-response (or luminance) 99.1% ˜100% corresponded with the Gamma reference voltages V₇, V₈ would be generated hardly by the spatial dithering. The method 3 cooperated with FIG. 9 of this invention is used to solve the problem above, which could be separated into the method of almost full black and the method of almost full white.

For the method of almost full black gray-level, we use the plurality gray-levels to be close to the full black level, and adjust the output voltage corresponded with the middle gray-level of the plurality gray-levels. The optical responses of the other gray-levels also be adjusted and followed with the middle output voltage. Until the user considers the variations between the plurality gray-levels are the most smooth, CPU30 figures out the target voltage of the selected Gamma voltage corresponded to the full black gray-level. Using the lookup-table or interpolation method could execute the figuration according to the voltage corresponded with the middle gray-level. In FIG. 9, for example, the gray-levels of 0% , 5% and 10% are used to find out the target Gamma voltage with full black gray-level (the user can also use five gray-levels of 0% , 2.5% , 5% , 7.5% and 10% to find out the full black gray-level Gamma voltage). At first, the user adjusts the output voltage of the 5% gray-level. In normal case, the output voltage variation of the 10% would follow the output voltage of the 5% gray-level, and the output voltage variation could be adjusted by the user. Until the user considers the variations of the three gray-levels are the most smooth, then applies the output voltage of the 5% gray-level to determine the full black gray-level corresponded voltage V₂′.

In the same way, for the almost full white gray-level, we use the plurality gray-levels to be close to the full white level, and adjust the output voltage corresponded with the middle gray-level of the plurality gray-levels. The optical-responses of the other gray-levels also be adjusted and followed with the middle output voltage. Until the user considers the variations between the plurality gray-levels are the smoothest, CPU30 figures out the target voltage of the selected Gamma voltage corresponded to the full white gray-level. Using the lookup-table or interpolation method could execute the figuration according to the voltage corresponded with the middle gray-level. In FIG. 9, for example, the gray-levels of 90% , 95% and 100% are used to find out the target Gamma voltage with the full white gray-level. At first, the user adjusts the output voltage of the 95% gray-level. In normal case, the output voltage variation of the 100% would follow the output voltage of the 95% gray-level, and the output voltage variation could be adjusted by the user. Until the user considers the variations of the three gray-levels are the most smooth, then applies the output voltage of the 95% gray-level to determine the full white gray-level corresponded voltage V₇′. So this invention completes reference voltages adjustment for the fill black and white gray-levels.

### Method 4. The Correction of Adjusting the External Voltages of the Data Drivers Directly

The method 4 of this invention is another method to determine the Gamma reference voltages for the data drivers, which is adjusting the external voltages of the data drivers 10 directly not through the equation (1) and (2).

Step 1: Generating two gray patches, one is produced by the spatial dithering and its luminance can be theoretically presented by a special digital code (d1). The other is generated by continuous pixels with a single one gray-level that could be adjusted by user.

Step 2: Applying one voltage to both the upper and lower external voltages (for example the upper V₄, the lower V₅, and V₄=V₅) of the continuous pixel gray patches, such that the luminance of all gray-levels within the two selected upper and lower external voltages are all the same.

Step 3: Adjusting the voltage applied to the upper and lower external voltages via changing the digital code of the continuous pixel gray patch when users are observing the gray patch from a distance.

Step 4: Recording the final voltage (V_{d1}) into the memory 50 when the luminance of the adjusted continuous pixel gray patch looks matching that of the spatial dithering gray patch.

Step 5: Generating two gray patches that be different from those of the step 1, one is produced by the spatial dithering and its luminance can be theoretically presented by a special digital code (d2), the other is a continuous pixel gray patch.

Step 6: Applying one voltage to both the upper and lower external voltages of the continuous pixel gray patches, such that the luminance of all gray-levels within the two selected upper and lower external voltages are the same, then repeating the steps (3)˜(4) to obtain another final voltage (V_{d2}).

Step 7: Determining two voltage values for the selected upper and lower external Gamma reference voltages based on the two gray-levels d₁ and d₂ with the voltages V_{d1} and V_{d2} further cooperating with the built-in voltages-to-code transfer function;

Step 8: Continuously, repeating the processing of steps (1)˜(7) to figure out all the external Gamma reference voltages of data drivers 10. Then this invention completes the auto Gamma correction.

### Second Embodiment. With a Detector

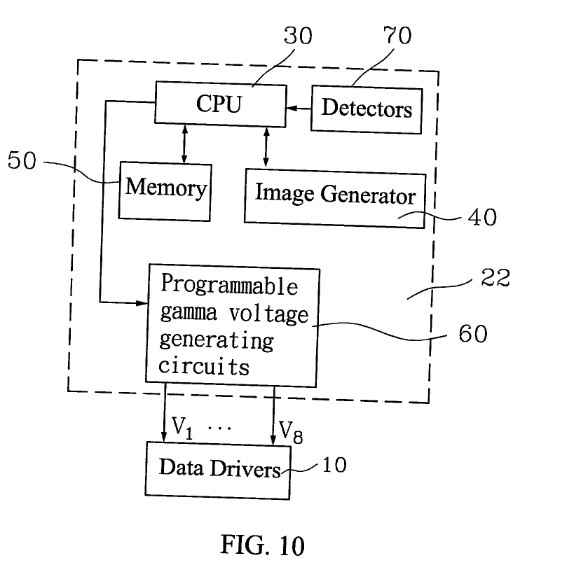

The second embodiment of this invention is developed for display manufactories that require low-cost apparatus to adjust Gamma reference voltage of their products. The hard ware of the second embodiment for this application is shown in FIG. 10, and it is almost matching FIG. 5 except at least a detector 70 is required.

To explain the FIG. 10 more completely, we describe all the block diagrams of FIG. 10. In which, FIG. 10 mainly includes an auto gamma correction system 22 coupled to the data drivers 10. For more detail description, the auto gamma correction system 22 at least including at least a detector 70, a central processing unit (CPU) 30, an image generator 40, memory 50, and a group of programmable gamma voltage generating circuits 60. The connection between these elements is that the output of detector 70 coupled to the CPU 30, the different outputs of CPU 30 coupled to the image generator 40 and the group of programmable gamma voltage generating circuits 60, the CPU 30 also connected with the memory 50 in bi-direction. The group of programmable gamma voltage generating circuits 60 could output different voltages V₁˜V₈ coupled to the data drivers. In FIG. 10, there are only eight Gamma reference voltages V₁˜V₈ used as an embodiment. In practically, the number of Gamma reference voltages depends on the requirements of data drivers.

The main functions of the above elements in FIG. 10, are described as follow:

Detector 70: used to measure optical energy emitting from the ongoing corrected display.

CPU 30: Coupling with the detector to record the optical energy value, and computing a new string of Gamma voltages to be adjusted during the correction process.

Image generator 40: The input of the image generator 40 is couple to the CPU 30 to generate at least two kinds of gray patches. One is produced by the technology of 1- or 2-dimensional spatial dithering, the other is produced by direct driving continuous pixels.

Memory 50: Coupling with the CPU 30 to store the target numerical values of Gamma reverence voltages and at least a target code-to-optical-response curve. Since code-to-voltage transfer function of data drivers from various companies may be quite different, the transfer function should be also recorded in the memory.

Group of programmable Gamma voltage generating circuits 60: Providing Gamma voltages to the data drivers 10 according to the numerical values computed by CPU 30, such that target code-to-optical-response curve can be achieved.

In which, the CPU 30 takes into considerations the data drivers' 10 code-to-voltage transfer functions to determine the target Gamma reference voltages according to the detect and comparison results from the detector; then produces a better image quality without any loss of gray-levels. For all the methods of the second embodiment are similar to those described above the first embodiment with methods 1˜2, except the following points:

(1) There is no scroll bar as shown in FIG. 7 required, since the optical energies of the gray patches A and B are compared by the detector 70. That is the comparison of gray patches A and B is not through the human eyes.

(2) If the two gray patches A and B are shown side by side, then two detectors are required to measure their optical energies respectively; or one detector is used with a position shift motor.

(3) The other method for one detector case is showing only one of the two gray patches at a time. At first, show patch A in the screen, measuring its energy, and then showing the other gray patch and measuring energy again. The energy of gray patch B is feedback to the CPU 30 to compare with that of gray patch A. If the two energies are different, then keep changing digital code of patch B, measuring its optical energy until optical energy of patch B is matched with the patch A.

In summary, compared with the prior art, the present invention provides advantageous characteristics as stated below:

(1) This invention is convenient for the users that the detectors are not necessary in the display system. More particularly, this invention is suitable for normal user to adjust the image quality of ongoing corrected displays;

(2) For the display manufacturers, the low accuracy instead of high accuracy detectors are required to execute the auto Gamma correction, so the cost of display is down; and

(3) There is no loss of the gray-levels by adjusting the external Gamma reference voltages to execute Gamma correction.

As discussed so far, in accordance with the present invention, there is provided the automatic Gamma parameter correction system and method for displays, wherein the Gamma reference voltages as well as the corresponding gray-scale values are adjustable. Such a Gamma parameter correction system provides a greater degree of freedom for the realization of the correction of Gamma parameters with no detectors or low-cost detectors. Consequently, the present invention has been examined to be progressive and has great potential in commercial applications.

Although this invention has been disclosed and illustrated with reference to particular embodiments, the principles involved are susceptible for use in numerous other embodiments that will be apparent to persons skilled in the art. This invention is, therefore, to be limited only as indicated by the scope of the appended claims.

What is claimed is

1. An auto gamma correction system for displays with adjusting reference voltages of data drivers, comprising:
a CPU, computing a string of digital codes that will be referenced during the correction process;
an image generator, coupling to the CPU to generate at least two kinds of gray patches;
a memory, coupling with the CPU to store a set of target values of Gamma reverence voltages of data drivers, code-to-voltage transfer functions of the data drivers, and at least a target code-to-optical-response curve;
a group of programmable Gamma voltage generating circuits, providing Gamma reference voltages to the data drivers according to numerical values computed by the CPU, such that the target code-to-optical-response curve can be achieved;
a group of data drivers, requiring a series of external reference voltages, hereinafter referred as Gamma reference voltages or Gamma voltages, to generate outnumbered analog voltages for the display to present adequate gray levels; and
wherein, the CPU determines the target Gamma reference voltages based on users' visual matching process after taking into considerations the data drivers' code-to-voltage transfer functions, then produces a better image quality without any loss of gray-levels.

2. The auto gamma correction system for displays with adjusting reference voltages of data drivers as recited in claim 1, wherein said at least two gray patches, one is produced by the technology of 1-dimensional spatial dithering, the other is produced by direct driving continuous pixels.

3. The auto gamma correction system for displays with adjusting reference voltages of data drivers as recited in claim 1, wherein said at least two gray patches, one is produced by the technology of 2-dimensional spatial dithering, the other is produced by direct driving continuous pixels.

4. The auto gamma correction system for displays with adjusting reference voltages of data drivers as recited in claim 1, wherein said memory records at least one target code-to-optical-response curve and the moment Gamma reference voltages of display operation.

5. An auto gamma correction method for displays with adjusting reference voltages of data drivers, which uses spatial dithering technology cooperated with two gray levels to generate an arbitrary gray patch, comprising:
(a) selecting adjacent two of Gamma reference voltages, wherein several gray levels exist, to be first corrected; then generating two gray patches, one is generated by spatial dithering technology, the other is a continuous pixel gray patch; luminance of these two patches should be within those bounded by the two selected Gamma voltages;
(b) adjusting the digital code of the continuous pixel gray patch from a distance, until the luminance of continuous pixel gray patch looks matching that of the spatial dithering gray patch, then recording the final digital code d₁ of the continuous pixel gray patch;
(c) generating another two gray patches that differ from those of the step (a), one is generated by spatial dithering technology, the other is a continuous pixel gray patch;
(d) adjusting the digital code of the continuous pixels gray patch from a distance, until the luminance of gray patch looks matching that of the spatial dithering gray patch, then recording the final digital code d₂ of the continuous pixel gray patch;
(e) figuring out the voltage values (V_{d1}, V_{d2}) corresponded to the digital codes (d₁, d₂) by the interpolation method with the built-in code-to-voltage transfer function;
(f) finding out final target voltage values for the two selected external Gamma reference voltages;
(g) repeating the steps (c)-(f) until the target numerical values of all Gamma reference voltages are figured out;
(h) adjusting the Gamma voltages to match with their target values by the programmable Gamma voltage generating circuits; and applying these Gamma voltages to the data drivers, then storing the adjusted Gamma reference voltages into a memory to complete the auto Gamma correction.

6. The auto gamma correction method for displays with adjusting reference voltages of data drivers as recited in claim 5, wherein said one spatial dithering gray patch of step (a) is cooperated with the ratio of black and white gray levels in 1:1 to produce a relative luminance 50% gray patch; the other gray patch is generated by continuous pixels with a single gray-level which could be adjusted by user.

7. The auto gamma correction method for displays with adjusting reference voltages of data drivers as recited in claim 5, wherein said one spatial dithering gray patch of step (c) is cooperated with the ratio of black and white gray levels in a certain ratio value to produce a specific relative luminance different from 50% gray patch; further, the 50% relative luminance and the specific relative luminance must be in the range that between the two corresponded external reference voltages; the other gray patch is generated by continuous pixels with a single gray-level which could be adjusted by users.

8. The auto gamma correction method for displays with adjusting reference voltages of data drivers as recited in claim 5, could be a method that adjusting the input Gamma voltages of data drivers to the target values immediately after a Gamma reference voltage has been determined, and the method completes the step (a) to (f), then further comprising:
(g) adjusting the two selected external Gamma reference voltages of step (f) to their target values by the programmable Gamma voltage generating circuits, then applying the determined Gamma voltages to data drivers;
(h) selecting another one Gamma voltage to be next adjusted; then determining the gray-level of the spatial-dithering gray patch for this selected Gamma voltage according to a set of pre-storage gray levels corresponded to the external reference voltages of the data drivers;
(i) generating a gray patch with the determined gray level by means of spatial dithering technology; then determining the target voltage value of the selected Gamma voltage via the users' visual matching process.
(j) adjusting immediately the input Gamma voltage of data drivers to its target value by the programmable Gamma voltage generating circuits after the target value has been determined,
(k) repeating step(h)˜(j) until all the Gamma reference voltages have been set.

9. An auto gamma correction method for displays with adjusting reference voltages of data drivers, by spatial-dithering technology with two specific gray-levels to generate an arbitrary gray patch, comprising:
(a) selecting two of Gamma reference voltages, wherein several gray levels exist, to be corrected at first; then generating two gray patches, one is generated by spatial dithering technology, the other is a continuous pixel gray patch; their luminance should be within those bounded by the two selected Gamma voltages;
(b) adjusting the digital code of the continuous pixel gray patch from a distance, until the luminance of continuous pixel gray patch looks matching that of the spatial dithering gray patch, then recording the final digital code d₁ of the continuous pixel gray patch;
(c) generating another two gray patches that different from those of the step (a), one is generated by spatial dithering technology, the other is a continuous pixel gray patch;
(d) adjusting the digital code of the continuous pixels gray patch from a distance, until the luminance of gray patch looks matching that of the spatial dithering gray patch, recording the final digital code d₂ of the continuous pixel gray patch;
(e) figuring out the voltage values (V_{d1}, V_{d2}) corresponded to the digital codes (d₁, d₂) by the lookup table and the interpolation method;
(f) finding out the final target voltages for the two selected external Gamma reference voltages;
(g) adjusting the two external Gamma reference voltages of step (f) to their target values by a group of programmable Gamma voltage generating circuits, then applying the determined voltages to data drivers;
(h) selecting another one Gamma voltage to be next adjusted; then determining the gray-level of the spatial-dithering gray patch for this selected Gamma voltage according to a set of pre-storage gray levels corresponded to the external reference voltages of the data drivers;
(i) generating a gray patch with the determined gray level by means of spatial dithering technology; then determining the target value of this Gamma voltage via the users' visual matching process.
(j) adjusting the input Gamma voltage of data drivers to its target value by the programmable Gamma voltage generating circuits.
(k) repeating step(h)˜(j) until all the Gamma reference voltages have been set.

10. The auto gamma correction method for displays with adjusting reference voltages of data drivers as recited in claim 9, wherein said gray-level of next gray patch for auto gamma correction of step (h) could be produced via applying full black and white with a preset gray-level, further using the integer area ratio to generate said gray-level.

11. The auto gamma correction method for displays with adjusting reference voltages of data drivers as recited in claim 9, wherein said gray-level value by the spatial dithering technology of step (i) could be also generated by means of a frame rate control technology.

12. The auto gamma correction method for displays with adjusting reference voltages of data drivers as recited in claim 9, wherein, if said selected Gamma voltage of step (h) is close to the full black gray-level voltage, the adjusting method could be that: using a plurality gray-levels closed to the full black level, and adjusting the output voltage corresponded with the middle gray-level of the plurality gray-levels, the other gray-levels also be adjusted and followed with the middle output voltage, until the user considers the variations between the plurality gray-levels are the most smooth, then figuring out the target voltage of the selected Gamma voltage.

13. The auto gamma correction method for displays with adjusting reference voltages of data drivers as recited in claim 9, wherein, if said selected Gamma voltage of step (h) is close to the full white gray-level voltage, the adjusting method could be that: using a plurality gray-levels closed to the full white level, and adjusting the output voltage corresponded with the middle gray-level of the plurality gray-levels, the other gray-levels also be adjusted and followed with the middle output voltage, until the user considers the variations between the plurality gray-levels are the most smooth, then figuring out the target voltage of the selected Gamma voltage.

14. An auto gamma correction method for displays with adjusting reference voltages of data drivers, which adjusting the external voltages of the data drivers directly, comprising:
(a) generating two gray patches, one is produced by the spatial dithering and its luminance can be theoretically presented by a special digital code (d₁), the other is generated by continuous pixels with a single one gray-level which could be adjusted by user;
(b) applying one voltage to both the upper and lower external voltages of the continuous pixel gray patches, such that the luminance of all gray-levels within the two selected upper and lower external voltages are all the same;
(c) adjusting the voltage applied to the upper and lower external voltages via changing the digital code of the continuous pixel gray patch when users are observing the gray patch from a distance;
(d) recording the final voltage (V_{d1}) into a memory when the luminance of the adjusted continuous pixel gray patch looks matching that of the spatial dithering gray patch;
(e) generating two gray patches that differ from those of the step 1, one is produced by the spatial dithering and its luminance can be theoretically presented by a special digital code (d₂), the other is a continuous pixel gray patch;
(f) applying one voltage to both the upper and lower external voltages of the continuous pixel gray patches, such that the luminance of all gray-levels within the two selected upper and lower external voltages are the same, then repeating the steps (c)˜(d) to obtain another final voltage (V_{d2});
(g) determining two voltage values for the selected upper and lower external Gamma reference voltages based on the two gray-levels d₁ and d₂ with the voltages V_{d1} and V_{d2} further cooperating with the built-in voltage-to-code transfer function;
(h) repeating the processing of steps (a)˜(g) to figure out all the external Gamma reference voltages of data drivers.

15. An auto gamma correction system for displays with adjusting reference voltages of data drivers, comprising:
at least a detector, measuring the optical energy emitting from the displays;
a CPU, coupling with the detector to record the optical energy values, and computing a new string of Gamma voltages to be adjusted during the correction process;
an image generator, coupling to the CPU to generate at least two kinds of gray patches;
a memory, coupling with the CPU to store the target numerical values of Gamma reverence voltages and at least a target code-to-optical-response curve;
a group of programmable Gamma voltage generating circuits, providing Gamma voltages to the data drivers according to numerical values computed by the CPU, such that the target code-to-optical-response curve can be achieved; and
wherein, the CPU takes into considerations the data drivers' code-to-voltage transfer functions to determine the target Gamma reference voltages according to the detect and comparison results from the detector; then produces a better image quality without any loss of gray-levels.

16. The auto gamma correction system for displays with adjusting reference voltages of data drivers as recited in claim 15, wherein said detector could be installed as two detectors that cooperated with two gray patches be parallel displayed.

17. The auto gamma correction system for displays with adjusting reference voltages of data drivers as recited in claim 15, wherein said detector could be installed as only one detector, further cooperated with a shift motor switching to detect two parallel displayed gray patches.

18. The auto gamma correction system for displays with adjusting reference voltages of data drivers as recited in claim 15, wherein said detector could be installed as only one detector, further cooperated with one gray patch be displayed in a time, and another gray patch be displayed in next time.
